(19) United States
(12) Patent Application Publication
(10) Pub. No.: US 2026/0357791 A1
(43) Pub. Date: Nov. 12, 2026

(54) Wind Turbine with Integral Energy Storage Uses Rotary Heat Exchangers to Accommodate Nacelle Yaw

(71) Applicant: The University of Nottingham, Nottingham (GB)

(72) Inventor: Seamus Garvey, Nottingham (GB)

(21) Appl. No.: 19/153,774

(22) PCT Filed: Jan. 30, 2024
(86) PCT No.: PCT/GB2024/050261

§ 371 Date: Aug. 5, 2025

(30) Foreign Application Priority Data
Feb. 6, 2023 (GB) 2301672.8

(51) Int. Cl. F03D 80/60; F03D 80/80

(52) U.S. Cl. CPC F03D 80/60; F03D 80/80; F05B 2260/20

(57) ABSTRACT

A wind turbine may be fitted with the facility store electricity indirectly using one or more thermal stores. The power-conversion machinery is installed within the wind turbine nacelle which rotates to point the turbine into the wind. The thermal storage is realised in the fixed frame—i.e. it does not rotate with the nacelle. The connection between the fixed frame and the rotatable frame is via one or more rotary heat exchangers. While the energy storage is charging, heat passes through the hot heat exchanger to a hot store or coldness passes through the cold heat exchanger to a cold store or both. During discharging, the opposite flows occur. Each rotary heat exchanger has a shell-and-tube configuration. The tube bundle rotates with the nacelle. The shell comprises one set of surfaces that does not rotate and one that does rotate.

### FIELD OF THE INVENTION

This invention relates to wind turbines that use heat pumping as a means of integrating energy storage with the wind turbine.

### BACKGROUND

Wind turbines have become a cost effective way to generate electricity and the outlook is now for wind power to achieve very high penetrations in energy systems across the world as society decarbonises its energy usage. This invention is motivated by the requirement to introduce energy storage into energy systems to complement high penetrations of wind power.

When wind power and the other intrinsically-inflexible forms of low-carbon generation collectively comprise only a small fraction of total generation in any energy system, the main concern about affordability is encapsulated in the so-called “Levelised Cost of Energy” (LCoE). The LCoE can be calculated by spreading the total cost system cost evenly over the lifetime of the system and then dividing the resulting annual cost by the amount of energy generated during that year. It is not necessary to be concerned about the intermittency of wind or solar resources in such cases because the demand for electricity would always exceed the supply from low-carbon generation and other naturally-flexible forms of generation can make up the difference.

When wind power and the other intrinsically-inflexible forms of low-carbon generation collectively comprise a large fraction of total generation in any energy system, then LCoE is not the only concern about affordability. Indeed LCoE is not even the main concern. In an energy system powered largely or fully by renewables and nuclear power, the costs associated with matching electricity supply to demand become very significant relative to the cost of the primary generation hardware.

There are several different ways to contribute flexibility back into an energy system powered mainly from renewables and inflexible nuclear power. These ways include (i) demand side response, (ii) interconnection, (iii) variable turn-down at the generators and (iv) energy storage. All of these will play some role in future but energy storage has particularly strong potential if the marginal costs of introducing the energy storage are low and if the roundtrip efficiency of that storage is good.

Many different possible ways have been devised to store energy and each has its own particular advantages and disadvantages. One of the few points on which nearly everyone active within energy storage can agree upon is that there is no one solution that obviates all of the others. When the requirement for flexibility in an electricity system is being driven largely by the intermittency of wind power, there are especially strong arguments for integrating the energy storage with at least some of the wind turbines. In the UK and other countries in Northern Europe like Ireland, France, Germany, Denmark and Sweden, the wind power resources are very large and solar irradiance is not very large so it is attractive to have a high penetration of wind power in the energy systems.

This integration of energy storage with wind turbines can itself be done in several different ways. These include using the mechanical power from the main rotor to: (i) raise water, (ii) compress air, (iii) generate heat directly and (iv) pump heat from a cold store into a hot store. This invention relates specifically to the use of thermal pumping for storing energy from wind turbines. The patent family arising from GB20130010717 (“Direct-drive power conversion system for wind turbines compatible with energy storage”) describes a system suitable for use in wind turbines that can act purely as a power transmission system converting the mechanical power from the slowly-turning main rotor into electrical power but can also send some energy into storage or recover some energy from storage using thermal pumping. The present invention is especially relevant as an adjunct to that system. It is also applies to numerous other possible arrangements within the nacelle where some of the mechanical work from the main rotor can sometimes be used to pump heat when it is appropriate to put energy into storage and where the available work from the main rotor can be supplemented at other times by allowing heat to flow back from the hot store to the cold store.

A core feature of the concept disclosed in GB20130010717 is that the working fluid used to pump heat is gaseous and this gas circulates in a closed loop with one side at elevated pressure and the other side at a lower pressure but the “lower pressure” is still substantially greater than ambient pressure. Typically that lower pressure would be between 15 bar and 50 bar. The reason for this is that the main compressor in the system can be connected directly to the wind turbine rotor in such cases and the intake swept volume per revolution for that compressor would not be excessive. The intake swept volume is a strong function of the lower pressure. The higher pressure side is typically around 25 times greater than the lower pressure in order to cause the required ratios of temperature to occur during adiabatic compression and expansion. For cost reasons, neither the hot store nor the cold store would be pressurised much above ambient pressure. Hence, to exchange heat between the higher pressure side of the closed loop and the hot store, it is necessary to use a heat exchanger. Similarly, to exchange heat between the lower pressure side of the closed loop and the cold store, it is necessary to use a heat exchanger.

The present invention teaches that these heat exchangers can comprise the rotating union between the fixed frame of the thermal stores and the rotatable frame of the wind turbine nacelle. In the original conception of GB20130010717 (as reported in [1]), the pressurised gas was envisioned to be transferred from the rotating frame into the stationary frame and this would require very competent sealing between the two frames. This invention solves that problem by configuring the heat exchangers at the rotating union such that the seals that necessarily exist between the components fixed to the stationary frame and the components that rotate with the nacelle (the rotatable frame) need seal against only very low pressures. 1 Garvey, S. D., Pimm, A. J., Buck, J. A., Woolhead, S., Liew, K. W., Kantharaj, B., Garvey, J. E. and Brewster, B. D., 2015. Analysis of a wind turbine power transmission system with intrinsic energy storage capability. Wind Engineering, 39(2), pp. 149-173.

The invention is based on the recognition that shell-and-tube heat exchangers in hollow cylindrical format and having net radial flow for the low-pressure fluid have already been conceived, built, tested and shown to be highly effective. Document U.S. Ser. No. 17/316,538 references numerous patent applications made in the UK in 2013 describing heat exchanger designs of this design. A discussion on such heat exchangers is present in [2]. 2 Hesselgreaves, J. E., Law, R. and Reay, D.. 2016. Compact Heat Exchangers: Selection, Design and Operation. Butterworth-Heinemann

### SUMMARY OF THIS INVENTION

GB20130010717 teaches that the function of a wind turbine transmission system can be delivered by a system in which a working gas circulates within a closed loop—being compressed by a primary compressor driven directly from the wind turbine rotor and subsequently expanded within a set of one or more expanders. At every point in the closed loop, the pressure of the working gas is significantly above atmospheric pressure. The gas compression and expansion takes place adiabatically and, consequently, the temperature of the working gas changes dramatically between the low pressure and high pressure sides of the closed gas circuit. This wind turbine transmission can enable the storage of substantial quantities of exergy (the ability to do work) in a thermal form. Some exergy may be stored in a thermal store dedicated to storing coldness and some exergy may be stored in a thermal store dedicated to storing heat. Although either one of those thermal stores could feasibly be omitted, the wind turbine transmission would nevertheless require two heat exchangers.

The core concept of GB20130010717 was envisioned primarily to be applicable to floating wind turbines where the entire floating platform would yaw bodily over the surface of the water so that the wind turbine could face its axis into the wind without the nacelle changing its orientation relative to the supporting structure. In such an arrangement, the two thermal stores that would retain the exergy would themselves be integral with the floating platform so that no relative rotation between the nacelle and the thermal stores was ever required. That configuration remains promising but the majority of wind turbines, even including those installed offshore, continue to utilise fixed-bottom arrangements-that is to say that the nacelle of the turbine is supported on a tall slender column that cannot itself rotate relative to the earth. A solution is necessary to enable the core concept of GB20130010717 to be applied in the context of fixed-bottom arrangements.

This invention resolve the issue of enabling rotation by providing that the relative motion can take place between different parts of the shells of the heat exchangers and configuring the heat exchangers such that they are, in effect, shell-and-tube heat exchangers of a hollow cylindrical format with a radial flow direction for the low-pressure fluid. At least one surface of the shell of each heat exchanger rotates with the nacelle while the remaining surfaces of the shell does not rotate and is coupled to a fluid circuit for the heat-transfer fluids that will convey the heat and coldness between the nacelle and the respective thermal stores.

Shell-and-tube heat exchangers are used predominantly where at least one of the fluids is at a pressure not much different from the surrounding atmospheric pressure. Most commonly, the second fluid in each shell-and-tube is at a higher pressure and (for obvious reasons) the higher-pressure fluid is normally configured to flow within the tubes while the lower-pressure fluid stays within the shell but outside of the tubes. This situation applies in the application of interest here. The lower-pressure fluid is used as a heat transfer fluid so that heat (and coldness) can be stored within containments that are not significantly pressurised. These containments would invariably be very large (typically several thousands of tons) and so it is not practicable to situate these large thermal stores at the top of a tower. In the application envisioned (wind turbine transmission systems as described in GB20130010717 that facilitate the storage and recovery of large amounts of energy), some relative motion must necessary between different parts of at least one fluid circuit and normally two fluid circuits. The key invention here is that this relative motion is accommodated within the shells of heat exchanger units.

This invention includes the following key features:
It pertains to the use of specific wind turbine transmission systems (systems for converting power from the slowly-rotating shaft of the wind turbine to electricity) that can also store exergy through thermal pumping following the method outlined in GB20130010717.
It involves the use of at least one cylindrical-format shell-and-tube type heat exchanger for transmission of heat between the high-pressure part of the pressurised gas circuit of the transmission system and a store for heat that is not significantly pressurised. Said transmission of heat would be implemented by the circulation of a heat-transfer gas. The gauge pressure within this(/these) heatexchangers would not exceed 2 bar.
It involves the use of at least one cylindrical-format shell-and-tube type heat exchanger for transmission of coldness between the lower-pressure part of the pressurised gas circuit of the transmission system and a store for coldness that is not significantly pressurised. Said transmission of coldness might be implemented by the circulation of a heat-transfer gas but it might, optionally, be implemented through the circulation of a liquid such as isopentane. The gauge pressure within this(/these) heatexchangers would not exceed 2 bar.
The shell of each heat exchanger comprises one surface (or set of surfaces) that rotates with the nacelle of the wind turbine and the remaining surface (or set of surfaces) forming that shell remain stationary relative to the fixed frame of reference.
The tube-bundle part of each heat-exchanger rotates with the nacelle so that there is no requirement for any dynamic seal within the closed gas circuit of the wind turbine transmission system.
The heat transfer fluid in the hot-side heat-transfer circuit would be circulated by a pump/blower/fan on that side of the circuit that experiences only moderately elevated temperatures relative to ambient.
The heat transfer fluid in the cold-side heat-transfer circuit would be circulated by a pump/blower/fan on that side of the circuit that experiences only moderately elevated temperatures relative to ambient.

### BRIEF DESCRIPTION OF THE DRAWINGS

FIG. 1 shows the arrangement of the invention schematically.

### DETAILED DESCRIPTION

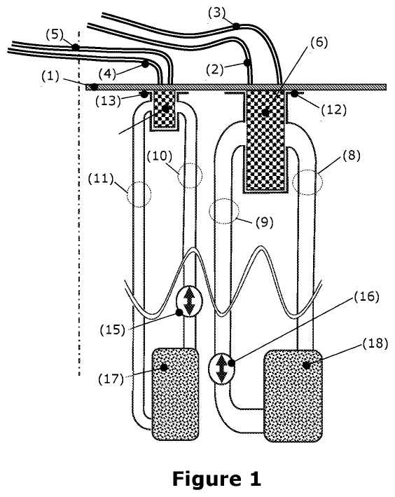

In the schematic illustration of FIG. 1, the heat exchangers are mounted on the underside of a base-plate (1) of the nacelle.

The full details of the power transmission system are not shown but items (2), (3), (4) and (5) depict pipes carrying pressurised working gas from the closed gas circuit of the transmission system.

The hot-flow-pipe (3) on the high-pressure side (which is also the hot side) of the closed gas circuit conveys pressurised gas from the primary compressor driven directly by the wind turbine rotor towards the hot-tube-bundle (6). The hot-return-pipe (2) on the high pressure side of the closed gas circuit conveys pressurised gas from the hot-tube-bundle (6) back to the expander set.

The cold-flow-pipe (4) on the lower-pressure side (which is also the cold side) of the closed gas circuit conveys pressurised gas from the expander set towards the cold-tube-bundle (7). The cold-return-pipe (5) on the lower-pressure side of the closed gas circuit conveys pressurised gas from the cold-tube-bundle (7) back to the primary compressor driven directly by the wind turbine rotor.

The hot-HXU-shell (12) surrounds the hot-tube-bundle (6) and one or more surfaces forming this hot-HXU-shell (12) rotate with the nacelle baseplate (1). Similarly, the cold-HXU-shell (13) surrounds the cold-tube-bundle (7) and one or more surfaces forming this hot-HXU-shell (13) rotate with the nacelle baseplate (1). The hot-HXU-shell (12) is connected via a fluid circuit with the high-temperature-store (18) via a first-hot-duct (8) and a second-hot-duct (9). The direction of heat transfer between the hot-tube-bundle (6) and the high-temperature-store (18) is determined by the direction in which the heat transfer fluid is circulated but in all cases, the first-hot-duct (8) serves to carry the heat and the second-hot-duct (9) serves to return the heat transfer fluid that has surrendered its heat. A hot-blower (16) is situated in the second-hot-duct (9) and said hot-blower (16) might comprise either a single reversible pump/fan/blower or it might comprise a system of one or more pump/fan/blower units together with suitable valving to enable fluid to be circulated in the appropriate way.

The cold-HXU-shell (13) is connected via a fluid circuit with the low-temperature-store (17) via a first-cold-duct (11) and a second-cold-duct (10). The direction of heat transfer between the cold-tube-bundle (7) and the low-temperature-store (17) is determined by the direction in which the heat transfer fluid is circulated but in all cases, the first-cold-duct (11) serves to carry the coldness and the second-hot-duct (10) serves to return the heat transfer fluid that has surrendered its coldness. A cold-blower (15) is situated in the second-cold-duct (10) and said cold-blower (15) might comprise either a single reversible pump/fan/blower or it might comprise a system of one or more pump/fan/blower units together with suitable valving to enable fluid to be circulated in the appropriate way.

The hot-HXU-shell (12) and the cold-HXU-shell (13) are each solids of revolution. The hottube-bundle (6) and the cold-tube-bundle (7) are also either solids of revolution or similar to solids of revolution in the sense that they can be rotated about the main nacelle axis (with the nacelle itself) by any amount and the effectiveness of the heat-exchange processes would not be compromised or enhanced significantly.

In FIG. 1 as drawn, the heat transfer fluid passing through the hot-HXU-shell (12) would travel in a radial-outward direction (left-to-right) when the high-temperature-store (18) is being charged-up. Conversely, this heat transfer fluid would travel in a radial-inward direction (right-to-left) when the high-temperature-store (18) is being discharged.

In FIG. 1 as drawn, the heat transfer fluid passing through the cold-HXU-shell (13) would travel in a radial-inward direction (right-to-left) when the low-temperature-store (17) is being charged-up. Conversely, this heat transfer fluid would travel in a radial outward direction (left-to-right) when the low-temperature-store (17) is being discharged.

High effectiveness of heat transfer is paramount in the operation of such systems. For this reason, contra-flow heat exchange would be implemented in the heat exchanger comprising the hot-HXU-shell (12) and the hot-tube-bundle (6). It would also be implemented in the heat exchanger comprising the cold-HXU-shell (13) and the cold-tube-bundle (7).

1. A system for transferring heat or coldness or both between a pressurised gas circuit located in a rotatable nacelle of a wind turbine and one or more thermal stores in a stationary frame of the wind turbine, the system comprising one or more shell-and-tube type heat exchangers, each of the one or more shell-and-tube type heat exchangers comprising:
a tube bundle connected to the pressurised gas circuit and configured to rotate with the nacelle; and
a shell comprising a set of one or more surfaces configured to rotate with the nacelle, and a set of one or more surfaces defining the remainder of the shell configured to remain stationary relative to the stationary frame of the wind turbine, wherein the shell is connected to a given thermal store.

2. A system according to claim 1 in which a heat transfer fluid circulating within the shell of each of the one or more shell-and-tube type heat exchangers is at a pressure lower than 2 bar gauge.

3. A system according to claim 1 in which a heat transfer fluid used to convey heat between a given shell-and-tube type heat exchanger and a given thermal store is caused to move by a pump/blower/fan installed on that side of the fluid circuit in which temperatures differ least from ambient temperature.

4. A system according to claim 1 in which the tube bundle and the shell of the one or more shell-and-tube type heat exchangers are arranged in a contra-flow configuration.

5. A pumped-thermal energy storage system integrated into the transmission of a wind turbine in which heat or coldness or both are transferred between a pressurised gas circuit in the wind turbine transmission system and one or more thermal stores in a stationary frame of the wind turbine using a system for transferring heat or coldness as described in claim 1.
